(19) United States
(12) Patent Application Publication
(10) Pub. No.: US 2026/0299700 A1
(43) Pub. Date: Oct. 1, 2026

(54) Augmented Reality System for Interacting with Objects Represented in a Physical Document

(71) Applicant: Maplebear Inc., San Francisco, CA (US)

(72) Inventors: Prithvishankar Srinivasan, Seattle, WA (US); Bryan Pham, London (CA); Brent Scheibelhut, Toronto (CA); Mark Oberemk, Toronto (CA); Rakshit Shukla, Mississauga (CA); Shaun Navin Maharaj, Vaughan (CA)

(21) Appl. No.: 19/093,201

(22) Filed: Mar. 27, 2025

(51) Int. Cl. G06F 3/01; G06F 3/0482; G06Q 30/0601; G06V 10/764; G06V 20/20; G06V 30/413; G10L 15/183; G10L 15/22; G10L 15/30

(52) U.S. Cl. CPC G06F 3/017; G06F 3/0482; G06Q 30/0603; G06V 10/764; G06V 20/20; G06V 30/413; G10L 15/183; G10L 15/22; G10L 15/30; G10L 2015/223

(57) ABSTRACT

A system for taking actions based on user interactions receives, from a computer system, image data of a document depicting one or more items. The system may use computer vision models to identify a user interaction with the document in the image data and determine an item depicted by the document that corresponds to the user interaction. The system detects a gesture that occurred based on the user interaction and the item. The system correlates the gesture with the identified item and causes the computer system to invoke a function corresponding to the gesture and identified item.

### BACKGROUND

Computer systems frequently include databases that manage various types of objects, allowing users to interact with those objects through the system's interface. However, physical, printed documents, while capable of containing information about such objects, lack the ability to connect directly with the functionality of the computer system. This disconnect arises because printed documents present unstructured information that is not inherently linked to the structured, digital data maintained by the database.

For example, a printed flyer might list items from a catalog that are also available online, but to purchase these items, a user would need to manually search for them in the online catalog and then engage with the system to complete the transaction. This process is inefficient and cumbersome, introducing unnecessary friction for users seeking to transition between physical and digital interactions with such objects. ome users may prefer physical documents to digital documents due to their unfamiliarity with accessing digital content. may less mobile and thus unable to go places to interact with objects they see on physical documents. Therefore, a system that performs actions based on user interactions with physical documents would be beneficial to some users.

### SUMMARY

In accordance with one or more aspects of the disclosure, a system for detecting and taking actions based on user interactions is described. In some embodiments, the system receives image data captured by a mobile device and detects user interactions with a document depicted by the image data. The system identifies an item shown in the document that corresponds to the user interaction and detects a gesture that occurred based on the user interaction itself and the item. In some embodiments, the system may use one or more computer vision models to detect and identify the document and item and one or more language or other machine learning models to determine a gesture associated with the document and item. The system correlates the gesture with the identified item and causes the computer system to invoke a function corresponding to the gesture and identified item. The function may cause the item to be added an order, the computer system to display information about the item, a mechanical system to disperse and pack the item, etc.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates a user interaction with a physical document, in accordance with one or more embodiments.

FIG. 3B illustrates a request confirmation of user intent via a user interface, in accordance with one or more embodiments.

FIG. 4 is a flowchart that illustrates an example process for invoking a function corresponding to a gesture, in accordance with one or more embodiments.

### DETAILED DESCRIPTION

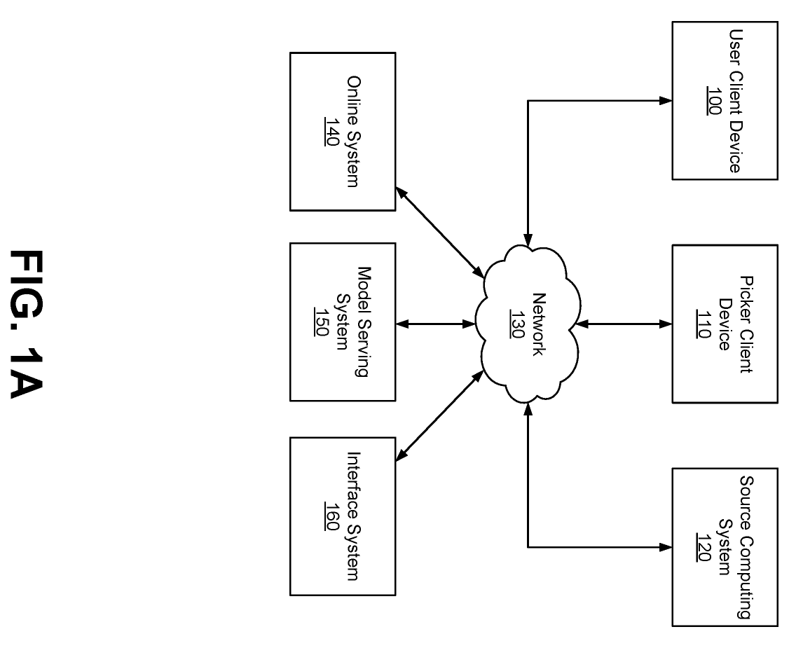

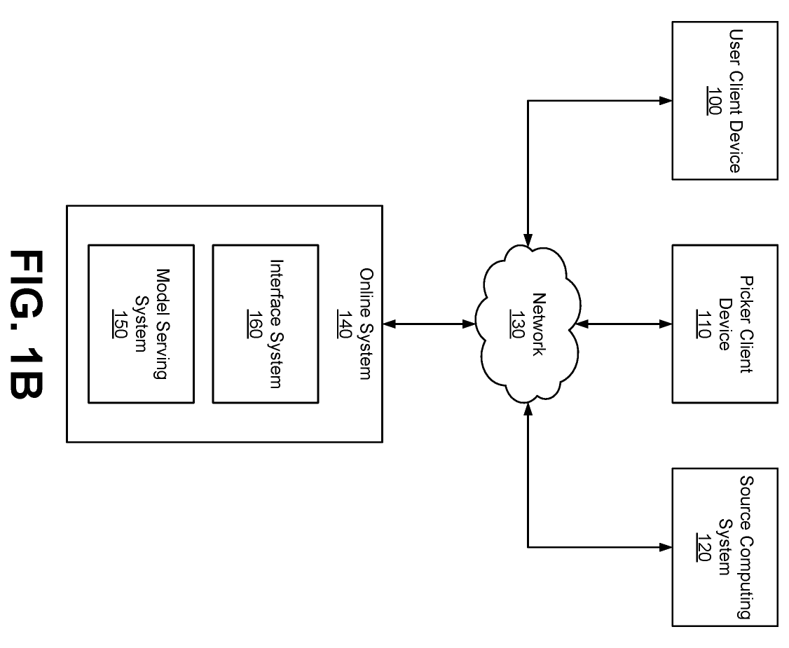

FIG. 1A illustrates an example system environment for an online system 140, in accordance with one or more embodiments. The system environment illustrated in FIG. 1A includes a user client device 100, a picker client device 110, a source computing system 120, a network 130, an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

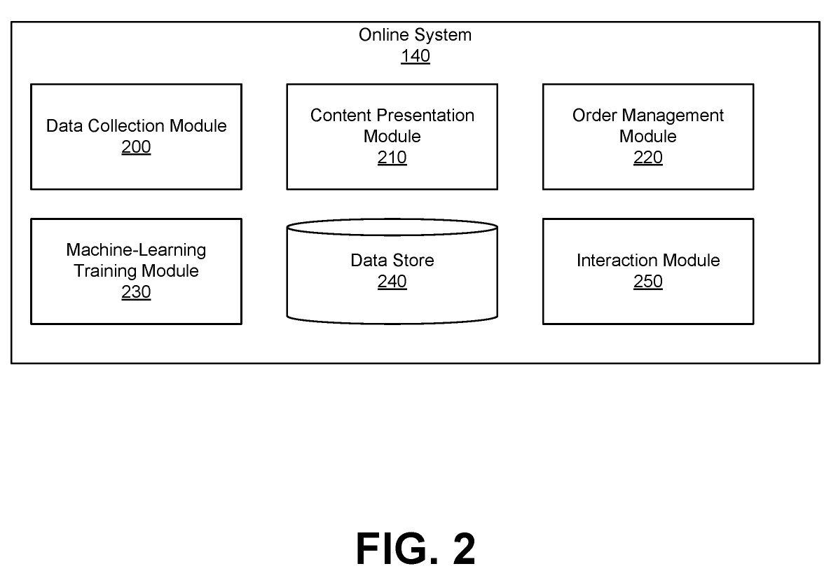

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regard to FIG. 2.

FIG. 1B illustrates an example system environment for an online system 140, in accordance with one or more embodiments. The system environment illustrated in FIG. 1B includes a user client device 100, a picker client device 110, a source computing system 120, a network 130, an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, and an interaction module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine-learning training module 230 may train any of machine-learn model deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data and may use databases to organize the stored data.

The interaction module 250 receives image data from user client device 100. The user client device 100 may be a mobile phone, tablet, augmented reality headset, virtual reality headset, or any mobile device including one or more cameras enabled to capture image data. In some embodiments, the interaction module 250 receive, from user client device 100, the image data along with a request to determine a user intent based on the image data. The interaction module 250 determine whether the image data depicts a document. For example, the interaction module 205 may apply an object detection model to identify and classify objects in the image data, where the objects include documents, other physical items, or text that are depicted by pixels within the image data.

The interaction module 250 identif objects detected within the image data. The interaction module 250 may use an object detection model to identify the objects. For example, the object detection model may localize objects in the image data, place a bounding box around each object, and classify the object in the bounding box. The object detection model may be trained using supervised machine learning methods to associate patterns in an image with object classification. In some embodiments, the object detection model is trained on images of items described in a catalog of items available to the user via the online system 140 each labeled with a text identifier of the item. The object detection model may be trained by the machine-learning training module 230, as described above. Examples of object detection models include segmentation models, You Only Look Once (YOLO) models, region-convolutional neural networks (R-CNN), and Single Shot MultiBox Detectors (SSDs). The interaction module 250 stores identifiers of objects detected within the image data in association with corresponding pixels in the data store 240.

In some embodiments, the interaction module 250 may apply a computer vision model that assesses the image data for edges or scans the image data for a document identifier, such as a machine-readable code, title, or alphanumerical tag and determine that the edges, when connected, form the outer edge of a document. In some embodiments, the interaction module 250 may perform text analysis to extract text from the image data and compare the text to document identifiers stored in the data store 240. The interaction module 250 may determine that an object that is overlaid with a detected document identifier is a document and store the pixels representing the document in association with the document identifier in the data store 240.

In some embodiments, to classify detected objects, the interaction module 250 items within the document using coordinate data. For instance, the interaction module 250 may retrieve coordinate data related to a document identifier of the document from data store 240. The coordinate data may describe a coordinate system mapped to the document and coordinates of objects, including items in a catalog, depicted or otherwise identified in the document. The interaction module 250 may match pixels of the image data to the coordinate system to map the document as shown in the image data to the coordinate system. For each detected object, the interaction module 250 may retrieve a set of coordinates (or coordinate ranges) that correspond to the object as shown in the image data. The interaction module 250 compare the retrieved set of coordinates to the coordinate data to identify the item or other object depicted at those coordinates.

The interaction module 250 may use one or more computer vision techniques to detect user interactions with objects in the image data. User interactions may be movements made by an individual and may be made in relation to other objects in the image data. User interactions include physical signals such as pointing, head tilting/nodding, eye movements, and other visual cues performed by an individual. The interaction module 250 may input the image data to a detection model, which outputs an indication a user interaction occurred and pixels in the image data corresponding to the gesture. The detection model may be trained by the machine-learning training module 230 to detect user interactions and pixels associated with each user interaction in image data. For example, the detection model may be trained on image data labeled with user interactions and corresponding pixels. The interaction module 250 may query the data store 240 with pixels corresponding to the user interaction to retrieve identifiers of objects depicted by the pixels. The interaction module 250 store an indication of detection of the user interaction in association with the pixels and identifiers of objects in the data store 240.

In some embodiments, user interactions also include voice commands or nonlexical sounds detected from audio data that corresponds to the image data. The interaction module 250 may detect voice commands within the audio data using speech recognition techniques. For example, the interaction module 250 may extract features from the audio data, such as by transforming the audio data into the frequency domain and differentiate speech segments from non-speech segments (e.g., background noise or silence) of the transformed audio data. The interaction module 250 may convert the speech segments into text using one or more machine learning models trained on speech data labeled with text. The interaction module 250 may apply natural language processing (NLP) techniques or language models, such as Large Language Models (LLMs), to the text to extract semantic meaning from the text and identify voice commands from the text. In some embodiments, the interaction module 250 employs a retrieval augmentation generation technique that uses one or more LLMs to identify voice commands. The interaction module 250 stores each detected voice command as a user interaction in the data store 240 along with image data captured at the same time as a portion of the audio data that includes the voice command and identifiers of objects detected in the image data.

In some embodiments, the interaction module 250 may use similar techniques to extract nonlexical sounds, such as grunts or murmurs, and use NLP or LLMs to assign meaning to the nonlexical sounds. For example, the interaction module 250 may determine that a grunt indicates an interest or affirmation that corresponds to another user interaction. The interaction module 250 may store each nonlexical sound and associated meaning as a user interaction in the data store 240 along with image data captured at the same time as a portion of the audio data that includes the nonlexical sound and identifiers of objects detected in the image data.

The interaction module 250 determine a gesture associated with each user interaction detected from the image data. A gesture an identifier of a user’s goal or desired outcome and may be associated with gesture data in the data store 240 that includes a textual description of the meaning of the gesture (e.g., the user’s end goal in performing the user interaction associated with the gesture) and pixel and audio data representative of user interactions that include the gesture. The interaction module 250 may access the pixel data or audio data corresponding to the user interaction. The interaction module 250 may apply a gesture model to the pixel data or audio data. The gesture model may be a machine learning model that classifies a user interaction as associat with a gesture of a plurality of gestures described in the data store 240. For example, the gesture model may determine that the user interaction of a user pointing at an object corresponds to the gesture “pointing.” The gesture model may be a machine learning model trained on image and audio data of user interactions and voice commands labeled with corresponding gestures or a language model that predicts a gesture based on a textual description of a user interaction and associated objects.

The interaction module 250 correlate the gesture with the identified item. For instance, the interaction module 250 may access gesture data corresponding to the gesture from the data store 240. The gesture data may include one or more actions associated with one or more types of items that the gesture may refer to. Actions may include adding an item to an order, placing an order, sending a notification to a picker client device 110, presenting a user interface, causing a mechanical system to distribute, pack, label, or ship the item, or any other suitable action. For example, the gesture data for the gesture “pointing” may correspond to the actions of “add to cart” or “provide information” for a food item and “provide schedule” for an item that requires an appointment to obtain (like a pair of glasses). The correlation between the gesture and item may be indicative of the user’s goal, such as to view a recipe, order an item, etc. The interaction module 250 determine one or more actions to take based on the correlation between the gesture and item. In some embodiments, the interaction module 250 appl an action model to the gesture data for the gesture and information describing the identified item. The action model may be a machine learning model trained to identify actions to take with respect to an identified item and associated gesture. The action module may be trained on gesture data and item information labeled with actions.

he interaction module 250 may cause the action(s) to be performed based on the correlation. In some embodiments, the interaction module 250 may generate a request for confirmation of the actions determined based on the correlation and send request for presentation at the user client device 100 that provided the associated image data. The interaction module 250 may instruct the user client device 100 to display the request along with a set of interactive elements that allow the user to approve or reject the action. In some embodiments, a user may enter text to an interactive element describing action they want to occur. The interaction module 250 may label the action described in the text with the gesture data and item information and store the labeled action in the data store 240 for training the action model.

The interaction module 250 receive indications of approval or rejection of actions, text inputs, and other interactions with the interactive elements from the user client device 100. The interaction module 250 determine whether to take action based on the indications. For an indication of approval, the interaction module 250 may take the action described in the request. For example, the interaction module 250 may add bananas to an order associated with the user client device 100 based on approval of a request asking, “Do you want to buy bananas?” In another example, the interaction send banana bread recipes for display at the user client device 100 upon assessing image data of a user pointing at a picture of banana bread and saying, “I should make this later.”

For rejections, the interaction module 250 may label request with the user interaction, identifiers of objects, and an indication of the rejection and store the labeled action as training data used by the machine-learning training module 230 to train the gesture model. In some embodiments, the interaction module 250 similarly label and store actions associated with approvals to use for training the gesture model. Further, the interaction module 250 may apply an explanation model, which a machine learning or language model trained to interpret text received in response to the request. The interaction module 250 may label the action with the output of the explanation model and may input the output of the explanation model as gesture data to the action model. The explanation model may be trained on the labeled actions by machine-learning training module 230.

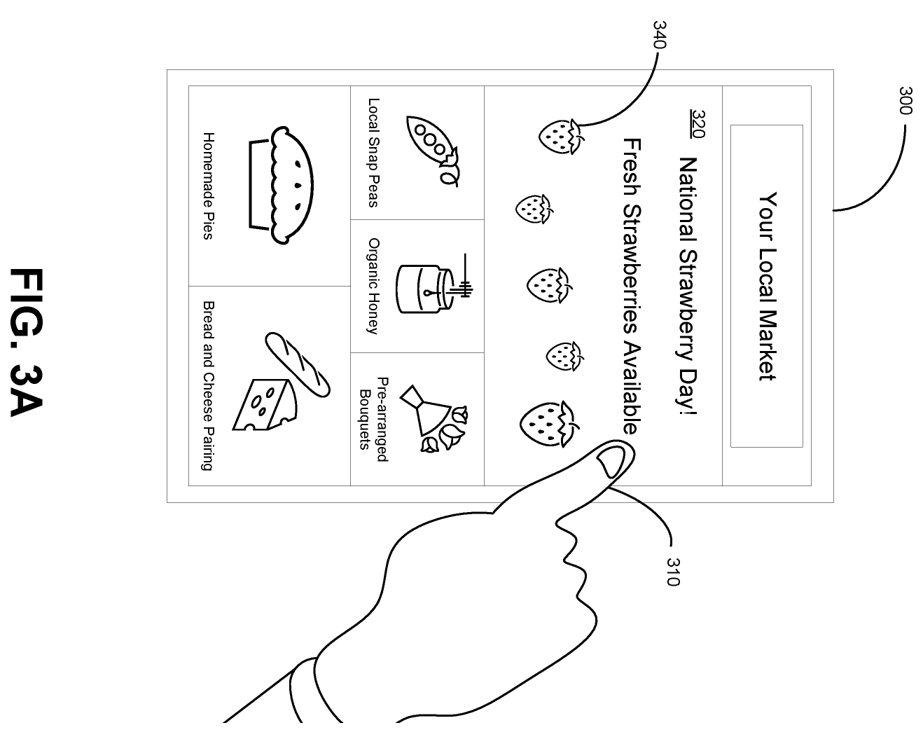

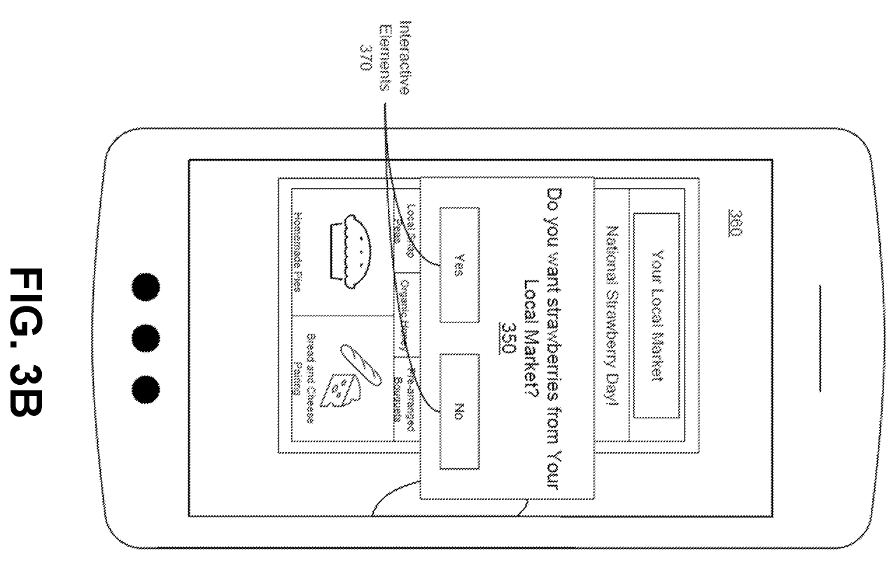

FIG. 3A illustrates an example of a user interaction 310 with a physical document 300, in accordance with one or more embodiments. In this example, the user interaction 310 is the user’s hand over a portion 320 of the physical document 300. The portion 320 of the physical document 300 describes availability of strawberries. A user client device 100 display the image data of the user’s hand over the physical document 300 via an AR display screen 360, as shown in FIG. 3B. Upon detecting the user interaction 310 with the physical document 300 and determining a gesture of “motioning to” the item “strawberries,” the user client device 100 display an interactive element 350 overlaid on the image data. The request include interactive elements 370 that a user can interact with to approve or reject an action to the gesture. In some embodiments, the AR display screen part of a headset AR system that displays image data and overlaid interactive elements 350 in a similar fashion to that shown in FIG. 3B.

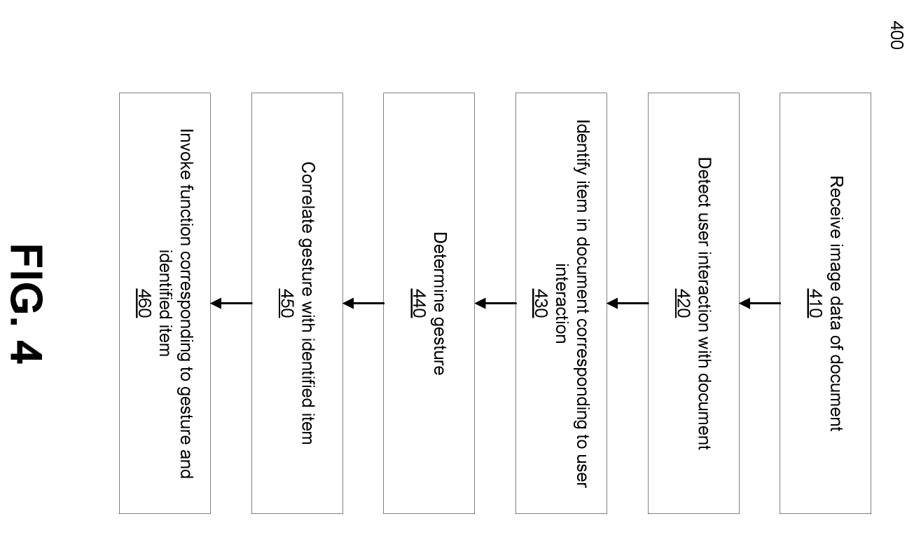

FIG. 4 is a flowchart that illustrates an example process for invoking a function corresponding to a gesture, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The interaction module 250 receives 410 image data from a user client device 100, where the image data depicts a document that includes one or more items. The user client device 100 may be a smart phone, tablet, wearable augmented reality system, wearable virtual reality system, etc. The document may be a physical document, or may be an electronic document, such as a webpage. The interaction module 250 may use an object detection model to identify the document in the image data or may scan a machine-readable code or other document identifier from the document. The interaction module 250 may access information about the document associated with its identifier, title, or machine-readable code from the data store 240.

The interaction module 250 detects 420 a user interaction with the document in the image data. Examples of user interactions include pointing at a portion of the document, marking the document using a writing instrument, issuing a voice command about the document, etc. The interaction module 250 may identify 430 an item corresponding to the user interaction. For example, the interaction module 250 may select pixels that correspond to the user interaction (e.g., pixels that the user pointed to, circled, etc.). The interaction module 250 may map a coordinate system to the document as shown in the image data and determine coordinates of mapping to the pixels. The interaction module 250 may access coordinate data related to the document, where the coordinate data includes mappings between coordinates in the document to items included in the document. The interaction module 250 may compare the coordinates of the pixels to the coordinate data to determine what item is depicted by the pixels and thus corresponds to the user interaction.

The interaction module 250 detects 440 gesture that occurred based on the user interaction and the item. For instance, the interaction module 250 may apply a gesture model trained to determine a gesture that occurred based on the type of user interaction and the item. In some embodiments, the interaction module 250 classifies the gesture as one of a plurality of gestures described in the data store 240. For example, the gestures may each be associated with an identifier, a textual description of the gesture, image data of an example gesture, etc. The interaction module 250 ransmit a request for confirmation of the gesture via a user interface at the user client device 100. The interaction module 250 may receive an indication of approval or rejection from the user client device 100.

The interaction module 250 correlates 460 the gesture with the identified item. For example, the interaction module 250 may use the information about the gestures, including actions to take with respect to gestures, stored in the data store 240 to determine one or more actions to take with respect to the item. For instance, a gesture of “pointing” to the identified item may be indicative of a user’s request to add the item to a virtual cart. The interaction module 250 may invoke a function corresponding to the gesture and identified item, as determined by the correlation. The function may be an action that the interaction module 250 takes with respect to the item, such as causing display of information related to the item, causing the item to be added to a virtual cart, causing the item to be moved in a warehouse by a mechanical system, and the like.

In some embodiments, the image data include corresponding audio data. The interaction module 250 may detect a voice command in the audio data and determine 430 the item based on the voice command. For example, the interaction module 250 may detect the voice command “I want to make that cake later today” and determine that the voice command corresponds to a Belgian chocolate cake shown in the document. The interaction module 250 may determine an activity described in the voice command, such as “baking.” The interaction module 250 may correlate the activity with one or more actions based on information describing activities stored in the data store 240. Based on the correlation, the interaction module 250 send a Belgian chocolate cake recipe for display at the user client device 100 or suggest ingredients for the cake to add to an order.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
receiving, by an online system having at least one processor, communication interface and memory, and from a computer system, image data of a document depicting one or more items;
detecting, by the at least one processor, a user interaction with the document in the image data;
identifying, by the at least one processor, an item of the one or more items in the document corresponding to the user interaction by:
detecting, by the at least one processor, a set of coordinates of the document corresponding to the user interaction; and
accessing, by the at least one processor, coordinate data associated with an identifier of the document, wherein the coordinate data includes mappings of coordinates of the document to items;
detecting, by the at least one processor, a gesture that occurred based on the user interaction and the item;
correlating, by the at least one processor, the gesture with the identified item; and
causing, by the at least one processor, the computer system to invoke a function corresponding to the gesture and identified item.

2. The method of claim 1, the method further comprising:
classifying, by the at least one processor, the gesture as one of a plurality of gestures the computer system is configured to detect.

3. The method of claim 1, wherein the computer system is a wearable augmented reality system.

4. The method of claim 1, further comprising:
transmitting, for display via a user interface by the at least one processor, a request for confirmation of the correlation between the gesture and the identified item.

5. The method of claim 1, further comprising:
detecting, by the at least one processor, the document in the image data based on a document identifier included in the document, wherein the document identifier is a machine-readable code.

6. The method of claim 1, wherein the image data includes corresponding audio data and the user interaction includes a voice command detected by a large language model.

7. The method of claim 1, wherein causing the computer system to invoke a function comprises causing the computer system to add the item to a virtual cart associated with the user.

8. The method of claim 1, wherein the item is one of a plurality of items in a catalog of items corresponds to a store identified in the document.

9. A non-transitory computer-readable storage medium storing instructions, that when executed, causes a processor to perform steps comprising:
receiving, from a computer system, image data of a document depicting one or more items;
detecting a user interaction with the document in the image data;
identifying an item in the document corresponding to the user interaction by:
detecting a set of coordinates of the document corresponding to the user interaction; and
accessing coordinate data associated with an identifier of the document, wherein the coordinate data includes mappings of coordinates of the document to items;
detecting a gesture that occurred based on the user interaction and the item;
correlating the gesture with the identified item; and
causing the computer system to invoke a function corresponding to the gesture and identified item.

10. The non-transitory computer-readable storage medium of claim 9, wherein the computer system is a wearable augmented reality system.

11. The non-transitory computer-readable storage medium of claim 9, the steps further comprising:
transmitting, for display via a user interface, a request for confirmation of the correlation between the gesture and the identified item.

12. The non-transitory computer-readable storage medium of claim 11, the steps further comprising:
detecting the document in the image data based on a document identifier included in the document, wherein the document identifier is a machine-readable code.

13. The non-transitory computer-readable storage medium of claim 9, wherein the image data includes corresponding audio data and the user interaction includes a voice command detected by a large language model.

14. The non-transitory computer-readable storage medium of claim 9, wherein causing the computer system to invoke a function comprises causing the computer system to add the item to a virtual cart associated with the user.

15. A system comprising:
a processor; and
a non-transitory computer-readable storage medium storing instructions, that when executed, causes the processor to perform steps comprising:
receiving, from a computer system, image data of a document depicting one or more items;
detecting a user interaction with the document in the image data;
identifying an item in the document corresponding to the user interaction;
detecting a gesture that occurred based on the user interaction and the item;
correlating the gesture with the identified item; and
causing the computer system to invoke a function corresponding to the gesture and identified item.

16. The system of claim 15, wherein the computer system is a wearable augmented reality system.

17. The system of claim 15, the steps further comprising:
transmitting, for display via a user interface, a request for confirmation of the correlation between the gesture and identified item.

18. The system of claim 17, the steps further comprising:
detecting the document in the image data based on a document identifier included in the document, wherein the document identifier is a machine-readable code.

19. The system of claim 15, wherein the image data includes corresponding audio data and the user interaction includes a voice command detected by a large language model.

20. The system of claim 15, wherein causing the computer system to invoke a function comprises causing the computer system to add the item to a virtual cart associated with the user.
